(19) United States
(12) Patent Application Publication
(10) Pub. No.: US 2017/0169419 A1
(43) Pub. Date: Jun. 15, 2017

(54) METHOD AND ELECTRONIC DEVICE FOR SETTING DEFAULT PAYMENT MODE ADAPTIVELY

(71) Applicants: Le Holdings (Beijing) Co., Ltd., Beijing (CN); LE SHI INTERNET INFORMATION & TECHNOLOGY CORP.BEIJING, Beijing (CN)

(72) Inventor: Mengya HUANG, Beijing (CN)

(21) Appl. No.: 15/250,640

(22) Filed: Aug. 29, 2016

Related U.S. Application Data
(63) Continuation of application No. PCT/CN2016/088944, filed on Jul. 6, 2016.

(30) Foreign Application Priority Data
Dec. 15, 2015 (CN) 201510939503.X

(51) Int. Cl. G06Q 20/32; G06Q 20/10

(52) U.S. Cl. CPC G06Q 20/3221; G06Q 20/102

(57) ABSTRACT

Embodiments of the present invention provide a method and apparatus for adaptively setting a default payment mode, applied to an Android terminal. The method includes: analyzing stored history payment behavior to acquire a payment mode adopted by the history payment behavior; acquiring a preferential payment mode according to the payment mode adopted by the history payment behavior; and setting the preferential payment mode as a default payment mode adopted by a payment behavior.

### CROSS REFERENCE TO RELATED APPLICATIONS

The present disclosure is a continuation of International Application No. PCT/CN2016/088944, filed on Jul. 6, 2016, which is based upon and claims priority to Chinese Patent Application No. 201510939503.X filed on Dec. 15, 2015, the entire contents of all of which are incorporated herein by reference.

### TECHNICAL FIELD

The disclosure relates to the field of the Internet technologies, and more particularly, to a method and an electronic device for setting a default payment mode adaptively.

### BACKGROUND

With the development of the Internet technologies, network payment, due to convenience thereof, is more and more extensively accepted and used by people. The network payment refers to monetary payment or cash flow done by those involved in electronic transactions, including consumers, manufacturers, and financial organizations, using secure electronic payment means. Payment behavior accomplish information transmission by using advanced technologies via digital circulation, and various payment mode adopted by the payment behavior are conducted in a digital manner.

Network payments via an IOS terminal are directly accomplished by using a default payment mode. However, with respect to Android terminals, users still need to make a selection among various network payment mode, so as to accomplish network payments. Since there are a variety of available payment mode, in the Android terminals, the users need to perform more selection operations, and as a result, the users fail to accomplish the payments timely.

### SUMMARY

In view of the above, the present disclosure provides a method and an electronic device for setting a default payment mode adaptively, such that an Android terminal does not need to make a selection in payment mode, which promotes the users accomplish the payments timely.

An embodiment of the present invention provides a method for setting a default payment mode adaptively, applied to an Android terminal, the method including:

analyzing stored history payment behavior to acquire a payment mode adopted by the history payment behavior;

acquiring a preferential payment mode according to the payment mode adopted by the history payment behavior; and

setting the preferential payment mode as a default payment mode adopted by a payment behavior.

A non-transitory computer-readable storage medium storing executable instructions that, when executed by an electronic device with a touch-sensitive display, cause the electronic device to:

analyze stored history payment behavior to acquire a payment mode adopted by the history payment behavior;

acquire a preferential payment mode according to the payment mode adopted by the history payment behavior; and

set the preferential payment mode as a default payment mode adopted by a payment behavior.

An embodiment of the present invention provides an electronic device for setting a default payment mode adaptively, including: at least one processor; and a memory communicably connected with the at least one processor for storing instructions executable by the at least one processor, wherein execution of the instructions by the at least one processor causes the at least one processor to:

analyze stored history payment behavior to acquire a payment mode adopted by the history payment behavior;

acquire a preferential payment mode according to the payment mode adopted by the history payment behavior; and

set the preferential payment mode as a default payment mode adopted by a payment behavior.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart illustrating a method for setting a default payment mode adaptively according to an embodiment of the present invention;

FIG. 2 is a schematic flowchart illustrating step 2 in the method for setting a default payment mode adaptively according to an embodiment of the present invention;

FIG. 3 is a schematic flowchart illustrating a method for setting a default payment mode adaptively according to another embodiment of the present invention;

FIG. 4 is a schematic flowchart illustrating a method for setting a default payment mode adaptively according to still another embodiment of the present invention;

FIG. 5 is a schematic structural diagram illustrating an apparatus for setting a default payment mode adaptively according to an embodiment of the present invention;

FIG. 6 is a schematic structural diagram illustrating a preference acquiring module in the apparatus for setting a default payment mode adaptively according to an embodiment of the present invention;

FIG. 7 is a schematic structural diagram illustrating an apparatus for setting a default payment mode adaptively according to another embodiment of the present invention;

FIG. 8 is a schematic structural diagram illustrating an apparatus for setting a default payment mode adaptively according to still another embodiment of the present invention; and

FIG. 9 is a schematic flowchart illustrating an application scenario of the method for setting a default payment mode adaptively according to an embodiment of the present invention.

FIG. 10 is a block diagram of an electronic device used to perform the method for setting a default payment mode adaptively.

### DETAILED DESCRIPTION

According to embodiments of the present invention, an Android terminal analyzes stored history payment behavior to acquire a payment mode adopted by the history payment behavior, such that a preferential payment term is acquired according to the payment terms adopted by the history payment behavior. According to the embodiments of the present invention, the preferential payment mode is set as the default payment mode adopted by the payment behavior, such that the Android terminal does not need to make a selection in the payment mode, which promotes timely network payment by the user. The embodiments of the present invention feature simple operations and convenient usage, and improve user experience in network payment.

Nevertheless, it is not necessary to require that any technical solution according to the embodiments of the present invention achieves all of the above technical effects.

To make a person skilled in the art better understand the technical solutions of the embodiments of the present invention, the technical solutions of the present invention are clearly and completely described with reference to the accompanying drawings of the embodiments of the present invention. Apparently, the described embodiments are only a part of the embodiments of the present invention, rather than the entire embodiments. Based on the embodiments of the present invention, all other embodiments derived by persons of ordinary skill in the art without any creative efforts shall fall within the protection scope of the present invention.

Specific implementations of the present invention are further described hereinafter with reference to drawings of the embodiments of the present invention.

An embodiment of the present invention further a method for adaptively setting a default payment mode, applied to an Android terminal, wherein the Android terminal includes a mobile phone, an PAD or the like on which an Android system is mounted.

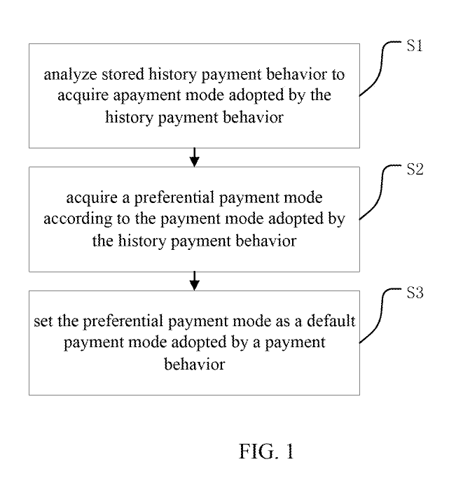

Referring to FIG. 1, the method includes the following steps:

In step S1: Stored history payment behavior is analyzed to acquire a payment mode adopted by the history payment behavior.

A user may conduct network payment via different clients such as Taobao, WeChat and the like, and may select a payment mode during the network payment process.

To accurately acquire a payment mode adopted by all the history payment behavior of the user, the history payment behavior according to the embodiment of the present invention include: history payment behavior conducted by the Android terminal via different clients.

Specifically, the Android terminal acquires the history payment behavior conducted by the user via different clients, and collects statistics for the payment mode adopted by the history payment behavior.

The payment modes include: bank card, Alipay, Yuebao and the like electronic accounts.

In step S2: A preferential payment mode is acquired according to the payment mode adopted by the history payment behavior.

The Android terminal analyzes the payment mode adopted by the history payment behavior conducted by the user via different clients to acquire the preferential payment mode.

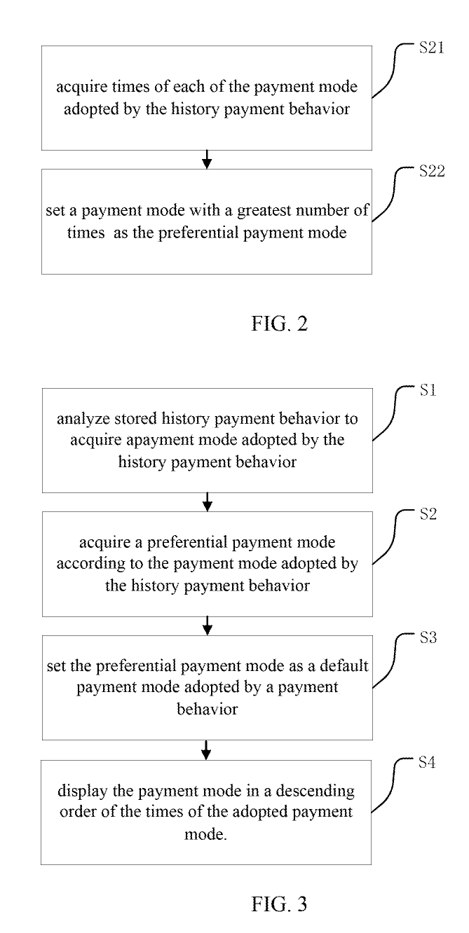

In a specific embodiment of the present invention, referring to FIG. 2, step S2 includes:

In step S21: times of each of the payment mode adopted by the history payment behavior is acquired.

Specifically, the Android terminal analyzes the payment mode adopted by the history payment behavior conducted by the user via different clients to acquire the times of the payment mode adopted by the history payment behavior.

In step S22: A payment mode with a greatest number of times is set as the preferential payment mode.

According to the times of the payment mode adopted by the history payment behavior, the payment mode with a greatest number of times is set as the preferential payment mode.

In step S3: The preferential payment mode is set as a default payment mode adopted by a payment behavior.

After the payment mode with a greatest number of times adopted by the user is set as the default payment mode, the user may directly complete network payment via the default payment mode, with no need to making a selection in the various payment mode. This simplifies the operation of the network payment for the user, and promotes timely network payment.

In a specific embodiment of the present invention, referring to FIG. 3, the method further includes the following step:

In step S4: The payment mode is displayed in a descending order of the times of the adopted payment mode.

The payment mode with a greatest number of times adopted by the user is displayed at a top place, such that the default payment mode is also displayed at a top place. When the user needs to change the default payment mode, the user generally makes a selection in the payment mode with a great adoption account, which may shorten the time for the user to browse the various payment mode.

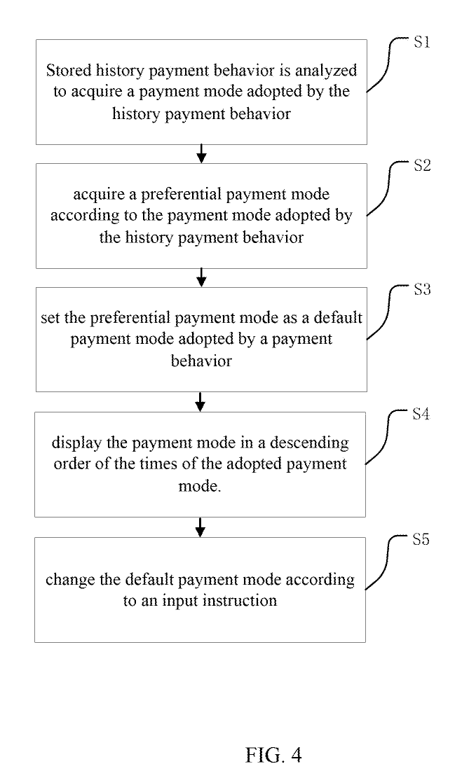

In a specific embodiment of the present invention, referring to FIG. 4, the method further includes the following step:

In step S5: The default payment mode is changed according to an input instruction.

In the embodiment of the present invention, although the default payment mode may be adaptively set, the set default payment mode may also be changed according to an input instruction. Therefore, the network payment mode is more flexible.

Another embodiment of the present disclosure further provides a non-transitory computer-readable storage medium storing executable instructions that, when executed by an electronic device, cause the electronic device to perform any of the embodiments described above of the method for setting a default payment mode adaptively. The computer readable storage medium includes any mechanism for storing or transferring information in a computer readable form (for example, a computer). For example, the computer readable storage medium includes a read-only memory (ROM), a random access memory (RAM), a disk storage medium, an optical storage medium, a flash storage medium, electricity, light, sound and other forms of propagation signals (for example, a carrier, an infrared signal, a digital signal and the like), and the like.

Corresponding to the above method, an embodiment of the present invention further provides an apparatus for adaptively setting a default payment mode, applied to an Android terminal, wherein the Android terminal includes a mobile phone, an PAD or the like on which an Android system is mounted.

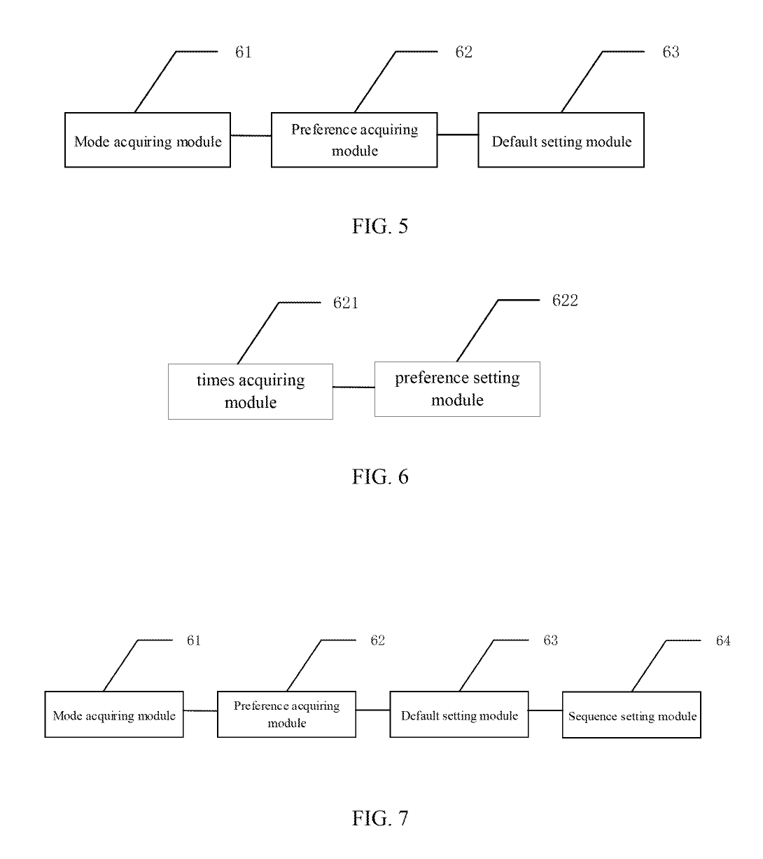

Referring to FIG. 5, the apparatus includes:

a mode acquiring module 61, analyzes stored history payment behavior to acquire a payment mode adopted by the history payment behavior;

a preference acquiring module 62, acquires a preferential payment mode according to the payment mode adopted by the history payment behavior; and

a default setting module 63, sets the preferential payment mode as a default payment mode adopted by a payment behavior.

According to the embodiment of the present invention, the preferential payment mode is set as the default payment mode adopted by the payment behavior, such that the Android terminal does not need to make a selection in the payment mode, in this way, the user conducts payment timely. Further, the embodiment of the present invention has the advantages of simple operations and convenient usage, and thus improves user experience in network payment.

A user may conduct network payment via different clients such as Taobao, WeChat and the like, and may select a payment mode during the network payment process.

To accurately acquire a payment mode adopted by all the history payment behavior of the user, the history payment behavior according to the embodiment of the present invention includes: history payment behavior conducted by the Android terminal via different clients.

Specifically, the Android terminal acquires the history payment behavior conducted by the user via different clients, and collects statistics for the payment mode adopted by the history payment behavior.

The payment modes include: bank card, Alipay, Yuebao and the like electronic accounts.

The Android terminal analyzes the payment mode adopted by the history payment behavior conducted by the user via different clients to acquire the preferential payment mode.

In a specific embodiment of the present invention, referring to FIG. 6, the reference acquiring module includes:

a times acquiring module 621, acquires times of each of the payment mode adopted by the history payment behavior; and

a preference setting module 622, sets a payment mode with a greatest number of times as the preferential payment mode.

Specifically, the Android terminal analyzes the payment mode adopted by the history payment behavior conducted by the user via different clients to acquire the times of the payment mode adopted by the history payment behavior.

According to the times of the payment mode adopted by the history payment behavior, the payment mode with a greatest number of times is set as the preferential payment mode.

After the payment mode with a greatest number of times adopted by the user is set as the default payment mode, the user may directly complete network payment via the default payment mode, with no need to making a selection in the various payment mode. This simplifies the operation of the network payment for the user, and promotes timely network payment.

In a specific embodiment of the present invention, referring to FIG. 7, the apparatus further includes:

a sequence setting module 64, displays the payment mode in a descending order of the times of the adopted payment mode.

The payment mode with a greatest number of times adopted by the user is displayed at a top place, such that the default payment mode is also displayed at a top place. When the user needs to change the default payment mode, the user generally makes a selection in the payment mode with a great adoption account, which may shorten the time for the user to browse the various payment mode.

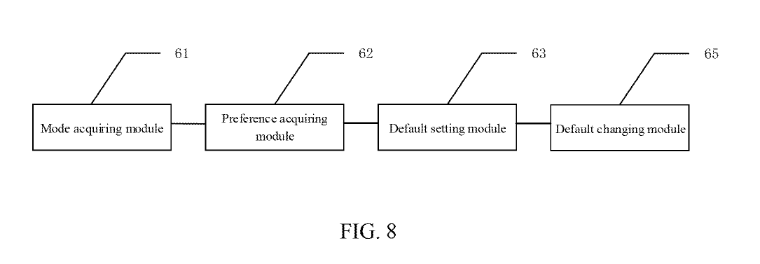

In a specific embodiment of the present invention, referring to FIG. 8, the apparatus further includes:

a default changing module 65, change the default payment mode according to an input instruction.

In the embodiment of the present invention, although the default payment mode may be adaptively set, the set default payment mode may also be changed according to an input instruction. Therefore, the network payment mode is more flexible.

Implementations of the embodiments of the present invention are further described with reference to a specific application scenario of the embodiments of the present invention.

The embodiment of the present invention is applicable to an Android mobile phone, and a user conducts network payments via the Android mobile phone, wherein the payment mode include: ICBC card, CCB card, CMB card, Alipay, and Yuebao.

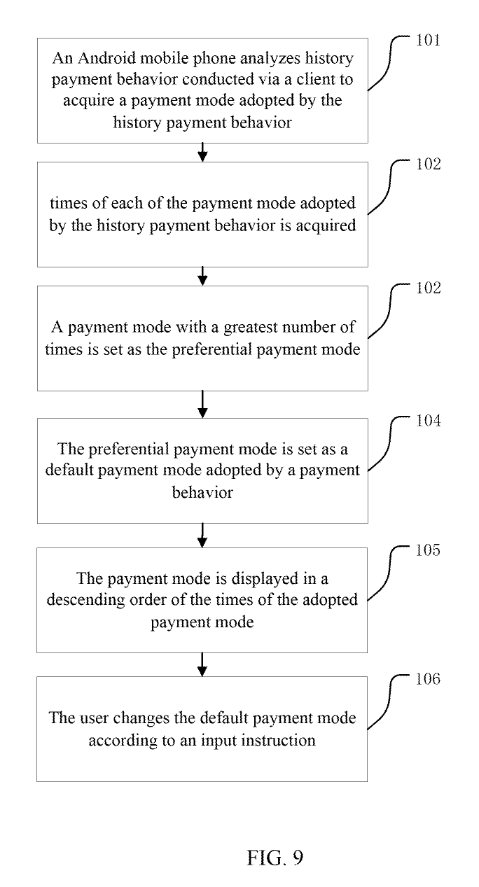

Referring to FIG. 9, in this application scenario, a method for adaptively setting a default payment mode includes the following steps:

In step 101: An Android mobile phone analyzes history payment behavior conducted via a client to acquire a payment mode adopted by the history payment behavior.

A user may conduct network payment via different clients such as Taobao, WeChat and the like, and may select a payment mode during the network payment process.

To accurately acquire a payment mode adopted by all the history payment behavior of the user, the history payment behavior according to the embodiment of the present invention includes: history payment behavior conducted by the Android terminal via different clients.

In step 102: times of each of the payment mode adopted by the history payment behavior is acquired.

Specifically, the times that the user conducts payments using an ICBC card is 10, the times that the user conducts payments using a CCB card is 50, the times that the user conducts payments using an CMB card is 16, the times that the user conducts payments using Alipay is 106, and the times that the user conducts payments using Yuebao is 8.

In step 103: A payment mode with a greatest number of times is set as the preferential payment mode.

Specifically, Alipay is set as the preferential payment mode.

In step 104: The preferential payment mode is set as a default payment mode adopted by a payment behavior.

After Alipay is set as the default payment mode, the user may directly complete network payment via Alipay, with no need to making a selection in the various payment mode. This simplifies the operation of the network payment for the user, and promotes timely network payment.

In step 105: The payment mode is displayed in a descending order of the times of the adopted payment mode.

The payment mode is sequenced, which are sequentially displayed as: Alipay, CCB card, CMB card, ICBC card, and Yuebao.

In step 106: The user changes the default payment mode according to an input instruction.

If the balance of an Alipay account of the user is insufficient, the user may change the default payment mode to CCB bank card according to the input instruction.

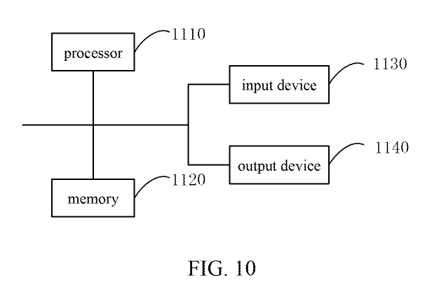

FIG. 10 is a block diagram of an electronic device used to perform the method for setting a default payment mode adaptively according to an embodiment of the present disclosure, as shown in FIG. 10, the device includes:

One or more processors 1110 and a memory 1120, FIG. 11 illustrates one processor 1110 as an example.

The device for the method for displaying watermark may further include an input device 1130 and an output device 1140.

The processor 1110, the memory 1120, the input device 1130 and the output device 1140 may be connected with each other through bus or other forms of connections. FIG. 11 illustrates bus connection as an example.

As a non-volatile computer readable storage medium, the memory 1120 may be configured to store non-volatile software program, non-volatile computer executable program and modules, such as program instructions/modules corresponding to the method for setting a default payment mode adaptively according to the embodiments of the disclosure (for example, the mode acquiring module 61, the preference acquiring module 62, the default setting module 63, as illustrated in FIG. 5). By executing the non-volatile software program, instructions and modules stored in the memory 1120, the processor 1110 may perform various functional applications of the server and data processing, that is, the method for setting a default payment mode adaptively according to the above mentioned embodiments.

The memory 1120 may include a program storage area and a data storage area, wherein, the program storage area may be stored with the operating system and applications which are needed by at least one functions, and the data storage area may be stored with data which is created according to use of the device for setting a default payment mode adaptively. Further, the memory 1120 may include a high-speed random access memory, and may further include non-volatile memory, such as at least one of disk memory device, flash memory device or other types of non-volatile solid state memory device. In some embodiments, optionally, the memory 1120 may include memory provided remotely from the processor 1110, and such remote memory may be connected with the device for setting a default payment mode adaptively through network connections, the examples of the network connections may include but not limited to internet, intranet, LAN (Local Area Network), mobile communication network or combinations thereof.

The input device 1130 may receive inputted number or character information, and generate key signal input related to the user settings and functional control of the device for setting a default payment mode adaptively. The output device 1140 may include a display device such as a display screen.

The above one or more modules may be stored in the memory 1120, when these modules are executed by the one or more processors 1110, the method for setting a default payment mode adaptively according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) mobile communication device, characterized in having a function of mobile communication mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smart toys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

A person skilled in the art shall understand that the embodiments may be described to illustrate methods, apparatuses (devices), or computer program products. Therefore, hardware embodiments, software embodiments, or hardware-plus-software embodiments may be used to illustrate the present invention. In addition, the embodiments of the present invention may further employ a computer program product which may be implemented by at least one non-transitory computer-readable storage medium with an executable program code stored thereon. The non-transitory computer-readable storage medium includes but not limited to a disk memory, a CD-ROM, and an optical memory.

The present invention is described based on the flowcharts and/or block diagrams of the method, apparatus (device), and computer program product. It should be understood that each process and/or block in the flowcharts and/or block diagrams, and any combination of the processes and/or blocks in the flowcharts and/or block diagrams may be implemented using computer program instructions. These computer program instructions may be issued to a computer, a dedicated computer, an embedded processor, or processors of other programmable data processing device to generate a machine, which enables the computer or the processors of other programmable data processing devices to execute the instructions to implement an apparatus for implementing specific functions in at least one process in the flowcharts and/or at least one block in the block diagrams.

These computer program instructions may also be stored a non-transitory computer-readable memory capable of causing a computer or other programmable data processing devices to work in a specific mode, such that the instructions stored on the non-transitory computer-readable memory implement a product including an instruction apparatus, wherein the instruction apparatus implements specific functions in at least one process in the flowcharts and/or at least one block in the block diagrams.

These computer program instructions may also be stored on a computer or other programmable data processing devices, such that the computer or the other programmable data processing devices execute a series of operations or steps to implement processing of the computer. In this way, the instructions, when executed on the computer or the other programmable data processing devices, implement the specific functions in at least one process in the flowcharts and/or at least one block in the block diagrams.

Although preferred embodiments are described, those skilled in the art may make modifications and variations to these embodiments based on the basic inventive concept of the present invention. Therefore, the preferred embodiments and all such modifications and variations shall fall within the protection scope subject to the appended claims. Apparently, a person skilled in the art may make various modifications and variations to the present invention without departing from the spirit and principles of the present invention. If such modifications and variations fall within the scope defined by the claims of the present invention and equivalent technologies thereof, the present invention is intended to cover such modifications and variations.

What is claimed is:

1. A method for setting a default payment mode adaptively, applied to an electronic device, comprising:
analyzing stored history payment behavior to acquire a payment mode adopted by the history payment behavior;
acquiring a preferential payment mode according to the payment mode adopted by the history payment behavior; and
setting the preferential payment mode as a default payment mode adopted by a payment behavior.

2. The method according to claim 1, wherein the history payment behavior comprise: history payment behavior conducted by the Android terminal via different clients.

3. The method according to claim 2, wherein the acquiring a preferential payment mode according to the payment mode adopted by the history payment behavior comprises:
acquiring times of each of the payment mode adopted by the history payment behavior; and
setting a payment mode with a greatest number of times as the preferential payment mode.

4. The method according to claim 3, further comprising:
displaying the payment mode in a descending order of the times of the adopted payment mode.

5. The method according to claims 1, further comprising:
changing the default payment mode according to an input instruction.

6. An electronic device, comprising:
at least one processor; and
a memory communicably connected with the at least one processor for storing instructions executable by the at least one processor, wherein execution of the instructions by the at least one processor causes the at least one processor to:
analyze stored history payment behavior to acquire a payment mode adopted by the history payment behavior;
acquire a preferential payment mode according to the payment mode adopted by the history payment behavior; and
set the preferential payment mode as a default payment mode adopted by a payment behavior.

7. The electronic device according to claim 6, wherein the history payment behavior comprises: history payment behavior conducted by the Android terminal via different clients.

8. The electronic device according to claim 7, wherein the step to acquire a preferential payment mode according to the payment mode adopted by the history payment behavior comprises:
acquiring times of each of the payment mode adopted by the history payment behavior; and
setting a payment mode with a greatest number of times as the preferential payment mode.

9. The electronic device according to claim 8, wherein the electronic device is further caused to:
display the payment mode in a descending order of the times of the adopted payment mode.

10. The electronic device according to claim 6, wherein the electronic device is further caused to:
change the default payment mode according to an input instruction.

11. A non-transitory computer-readable storage medium storing executable instructions that, when executed by an electronic device with a touch-sensitive display, cause the electronic device to:
analyze stored history payment behavior to acquire a payment mode adopted by the history payment behavior;
acquire a preferential payment mode according to the payment mode adopted by the history payment behavior; and
set the preferential payment mode as a default payment mode adopted by a payment behavior.

12. The non-transitory computer-readable storage medium according to claim 11, wherein the history payment behavior comprises: history payment behavior conducted by the Android terminal via different clients.

13. The non-transitory computer-readable storage medium according to claim 12, wherein the step to acquire a preferential payment mode according to the payment mode adopted by the history payment behavior comprises:
acquiring times of each of the payment mode adopted by the history payment behavior; and
setting a payment mode with a greatest number of times as the preferential payment mode.

14. The non-transitory computer-readable storage medium according to claim 13, wherein the electronic device is further caused to:
display the payment mode in a descending order of the times of the adopted payment mode.

15. The non-transitory computer-readable storage medium according to claim 11, wherein the electronic device is further caused to:
change the default payment mode according to an input instruction.
